(19) United States
(12) Patent Application Publication
(10) Pub. No.: US 2026/0346851 A1
(43) Pub. Date: Nov. 5, 2026

(54) METHOD AND APPARATUS FOR DETERMINING A DEGREE OF WETNESS OF A ROAD

(71) Applicant: MERCEDES-BENZ GROUP AG, Stuttgart (DE)

(72) Inventors: Christian KOBETZ, Horb (DE); Konstantin FICHTNER, Sindelfingen (DE)

(21) Appl. No.: 19/487,652

(22) PCT Filed: Apr. 18, 2024
(86) PCT No.: PCT/EP2024/060637

§ 371 Date: Nov. 25, 2025

(30) Foreign Application Priority Data
May 30, 2023 (DE) 10 2023 002 202.0

(51) Int. Cl. B60W 40/06; G01N 29/036

(52) U.S. Cl. CPC B60W 40/06; G01N 29/036; B60W 2420/54; B60W 2520/10; G01N 2291/022; G01N 2291/2632

(57) ABSTRACT

During a journey of the vehicle on the road front acoustic signals are detected by a front external microphone arranged in the region of a front end of the vehicle and rear acoustic signals are detected by a rear external microphone arranged in the region of a rear end of the vehicle. A noise level difference between the front acoustic signals and the rear acoustic signals. The degree of wetness of the road is determined from a specified value matrix using the noise level difference and a current driving speed of the vehicle.

### BACKGROUND AND SUMMARY OF THE INVENTION

Exemplary embodiments of the invention relate to a method for determining a degree of wetness of a road, as well as to an apparatus for determining a degree of wetness of a road.

A method for determining a road status during the driving operation of a motor vehicle is known from DE 102 59 979 A1, wherein a part of a sound created when rolling a vehicle tire on a road is detected and a sound level signal describing this sound is created by means of the detected sound. Furthermore, a frequency signal describing the sound level signal is determined. This frequency signal is divided into two partial regions by a limit frequency, which in each case is assigned to an associated frequency band.

In each case, an intensity value is determined for two frequency bands from the associated partial region of the frequency signal, which is characterized for sound intensity present in a frequency band. Furthermore, an intensity ratio is formed, in which a first intensity value of a first frequency band is divided by a second intensity value of a second frequency band, wherein the intensity ratio is used for determining the road status. A thickness of a layer of water located on the road is determined as a road status.

Furthermore, a method for detecting the wetting of a road surface with a liquid is known from DE 42 13 221 A1, wherein the road surface is driven by means of a vehicle, the wheels of which roll on the road. The method comprises the steps:
detecting a spray water noise or a rolling noise of a wheel of the motor vehicle by means of a microphone arranged on the motor vehicle and creating an output signal corresponding to the detected noise,
band pass filtering of the output signal, in order to separate a frequency range that is typical for the wetting of the road,
effective value creation of the filtered output signal,
deep-pass filtering of the effective value,
assigning the effective value to a value of the wetting of the road surface while compensating for an influence of variables other than the wetting of the effective value and
outputting this value.

A method for determining a water layer height on a road is known from DE 10 2004 016 900 A1, wherein it is provided to detect sound emissions at the front wheel and at the rear wheel by means of microphones and to compare them to each other and to determine the water layer height from the signal difference.

A method for detecting a wet road by means of an acoustic sensor system is known from DE 10 2019 203 191 B3, wherein it is provided to arrange an ultrasonic transducer in the region of the front and the rear bumper and to determine the outside level. In the method, the noise levels of the ultrasonic transducer are correlated with additional detected data of a sensor system for detecting uneven road surfaces, thus a continuously wet road can be differentiated from a road filled with water-filled bumps.

A method is known from DE 10 2019 218 492 A1, in which wetness values of a road are detected on the vehicle by means of an ultrasound sensor acoustically at the front, at the rear and laterally and a moved object is detected in the vehicle's surroundings depending on the wetness values.

A method for determining a wetness value of a road is known from DE 10 2020 216 574 A1, wherein capacitor sensors are provided on the front and at the rear of the vehicle, the frequency change of which is used to determine wetness parameters.

Exemplary embodiments of the invention are directed to a novel method and a novel apparatus for determining a degree of wetness of a road.

In a method for determining a degree of wetness of a road using acoustic signals, these are detected by means of a microphone arrangement arranged on a vehicle driving on a road.

According to the invention, during a journey of the vehicle on the road, front acoustic signals are detected by means of at least one front external microphone arranged in the region of a front end of the vehicle and rear acoustic signals are detected by means of at least one rear external microphone arranged in the region of a rear end of the vehicle. Furthermore, during the journey of the vehicle on the road, in an analysis, a noise level difference between the front acoustic signals and the rear acoustic signals is determined, wherein the degree of wetness of the road is determined from a specified value matrix using the noise level difference and a current driving speed of the vehicle.

For automated, in particular highly automated or autonomously operated vehicles, it is important to detect the degree of wetness of the road, in order to adapt longitudinal and/or transverse control to a view of environment detection sensors that is dependent on the degree of wetness and to traction that is dependent on the degree of wetness.

A particularly precise and reliable determination of the degree of wetness of the road is possible by means of the present method. Microphones already provided on the vehicle for determining acoustic probe signals of emergency vehicles can be used in a particularly advantageous manner for determining the acoustic signals.

Therefore, wetness sensors, for example arranged in a wheel arch, can be omitted, resulting in particularly low cost of materials and costs for realizing the method.

In a possible embodiment of the method, the value matrix is determined vehicle-specifically for different degrees of wetness and different vehicle speeds in road tests, wherein in each case noise level differences between the acoustic signals detected by means of the outer microphone is determined at different vehicle speeds for different degrees of wetness and is removed in the value matrix. Such a value matrix enables a particularly simple and reliable determination of the degree of wetness of the road during the operation of the vehicle.

In a further possible embodiment of the method, initially an amount of spray is determined using the noise level difference. The degree of wetness of the road is derived from the amount of spray, wherein an increasing degree of wetness is concluded when there is an increasing amount of spray. As the noise level increases only very little at the front external microphone with an increasing amount of spray, in contrast the noise level clearly increases at the rear external microphone, the spray as a parameter directly dependent on the degree of wetness of the road is particularly suitable for simple, exact and reliable detection of the degree of wetness of the road.

In a further possible embodiment of the method, dependent noise level differences between the acoustic signals detected by means of the external microphones are determined in the value matrix for different degrees of wetness and different driving speeds of the vehicle, depending on an amount of spray that is dependent on the degree of wetness, and are removed in the value matrix, such that a simple determination of the amount of spray from the matrix is possible, and consequently a simple determination of the degree of wetness from the determined amount of spray is possible.

In a further possible embodiment of the method, the degree of wetness determined using the noise level difference is checked for plausibility with data determined by means of a visual rain sensor. Such a rain sensor, which is very often already provided for a rain sensor-controlled control system of a screen wiper in the region behind a windscreen of the vehicle, can further increase the reliability of the determination of the degree of wetness.

The apparatus for determining a degree of wetness of a road using acoustic signals detected by means of a microphone arrangement arranged on a vehicle driving on the road, according to the invention, comprises at least one front external microphone arranged in the region of a front end of the vehicle for detecting front acoustic signals during a journey of the vehicle on the road and at least one rear external microphone arranged in the region of a rear end of the vehicle for detecting rear acoustic signals during the journey of the vehicle on the road. The apparatus further comprises an analysis for determining a noise level difference between the front acoustic signals and the rear acoustic signals and for determining the degree of wetness of the road from the noise level difference and a current driving speed of the vehicle from a specified value matrix.

A particularly precise and reliable determination of the degree of wetness of the road is possible by means of the present apparatus. Microphones already provided on the vehicle for determining acoustic probe signals of emergency vehicles can be used in a particularly advantageous manner for determining the acoustic signals. Therefore, wetness sensors, for example arranged in a wheel arch, can be omitted, resulting in particularly low cost of materials and costs for realizing the apparatus.

Exemplary embodiments of the invention are explained in more detail in the following using the drawings.

### BRIEF DESCRIPTION OF THE DRAWING FIGURES Here:

FIG. 1 schematically shows a plan view of a vehicle located on a road and

FIG. 2 schematically shows a block diagram of an apparatus for determining a degree of wetness of a road.

Parts corresponding to each other are provided with the same reference signs in all the figures.

### DETAILED DESCRIPTION

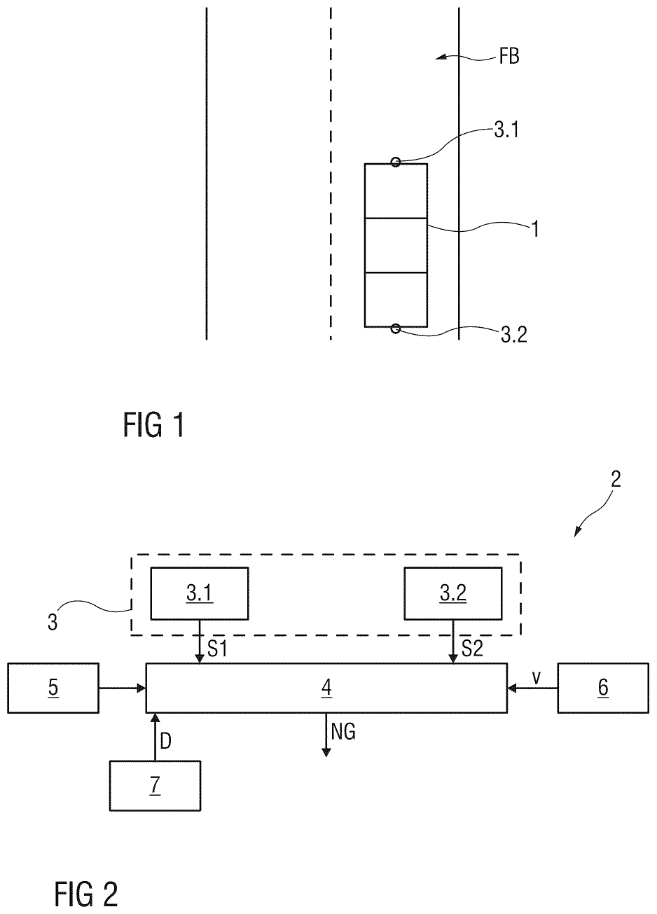

FIG. 1 illustrates a plan view of a vehicle 1 located on a wet road FB and FIG. 2 illustrates a block diagram of a possible exemplary embodiment of an apparatus 2 for determining a degree of wetness NG of the road FB, wherein the vehicle 1 comprises the apparatus 2.

The apparatus 2 comprises a microphone arrangement 3 having two external microphones 3.1, 3.2, wherein one of the external microphones 3.1 is a front external microphone 3.1 arranged in the region of a front end of the vehicle 1 and an external microphone 3.2 is a rear external microphone 3.2 arranged in the region of a rear end of the vehicle 1. For example, the front external microphone 3.1 is arranged in the region of a front bumper or a front bumper covering and the rear external microphone 3.2 is arranged in the region of a rear bumper or a rear bumper covering.

The apparatus 2 further comprises an analysis unit 4, a value matrix 5 coupled to the analysis unit 4 or comprised of this, and a speed transmitter 6, which delivers a current driving speed v of the vehicle 1 to the analysis unit 4.

In the exemplary embodiments of the apparatus 2 (not shown in more detail), this can comprise further external microphones 3.1, 3.2, wherein for example, two front external microphones 3.1 are arranged in the region of the front end of the vehicle 1 and two rear external microphones 3.2 in the region of the rear end of the vehicle 1.

To determine the degree of wetness NG of the road FB, during a journey of the vehicle 1 on the road FB, front acoustic signals S1 are detected by means of the front external microphone 3.1 and rear acoustic signals S2 are detected by means of the rear external microphone 3.2.

Spray detection is carried out using a delta analysis of the two acoustic signals S1, S2, carried out by means of the analysis unit 4. With an increasing amount of spray, noise level at the front external microphone 3.1 only increases very little. In contrast, the noise level at the rear external microphone 3.2 clearly increases with an increasing amount of spray. Thus, the spray as a parameter directly dependent on the degree of wetness NG of the road FB is suitable for deriving the degree of wetness NG of the road FB from this.

As the amount of spray on the vehicle 1 is dependent on its driving speed v, the determination of the degree of wetness NG takes place in particular retroactively from the amount of the spray, depending on the current driving speed v.

The determination of the degree of wetness NG is therefore carried out by a comparison of the determined amount of the spray with the current driving speed v with values stored in the value matrix 5. The value matrix 5 is determined vehicle-specifically for a respective vehicle 1 or a respective vehicle type, for example, limousine, station wagon, off-road vehicle, transporter, sport utility vehicle, for different

degrees of wetness NG and different vehicle speeds v in road tests, wherein in each case noise level differences between the acoustic signals S1, S2 detected by means of the outer microphones 3.1, 3.2 is determined at different vehicle speeds v for different degrees of wetness NG and is removed in the value matrix 5. The noise level differences are therefore determined depending similarly on the respective amount of spray and is removed in the value matrix 5.

From the value matrix 5 generated in this way, a value corresponding to a pair of values consisting of the determined noise level difference and the current vehicle speed v is read from the amount of spray during operation of the vehicle 1, wherein the degree of wetness NG of the road surface FB, which depends on this value, is determined from this value.

Therefore, different degrees of amount of spray can be stored in the value matrix. The degrees divide the amount of spray for example, into “no spray”, “light spray”, “medium spray” and “high spray”. Dependent thereon, the degree of wetness NG derived therefrom can be classified into the degrees “dry”, “light”, “medium” and “high”.

For example, the value matrix 5 as a 5×4 matrix is created for five different driving speeds v of the vehicle 1 and the four degrees of the amount of spray “no spray”, “light spray”, “medium spray” and “high spray”. The vehicle speeds v are, for example, 20 km/h, 40 km/h, 60 km/h, 80 km/h and 100 km/h. Notwithstanding this provision, more driving speeds v and/or finer divisions with low distances between the driving speeds v can be possible. A maximum driving speed v for the value matrix 5, for example, is a maximum speed permitted in the automated driving operation. Another classification of the degree of the amount of spray is also possible.

If the value matrix 5 is used during the driving operation of the vehicle 1 for the above-described determination of the degree of wetness NG from a current driving speed v and a determined amount of spray, the following relationships between the current driving speed v, the determined amount of spray and the degree of wetness NG result from the example described above:
driving speed v=20 km/h and degree of wetness NG “light”: “light spray”;
driving speed v=60 km/h and degree of wetness NG “light”: “light spray”;
driving speed v=100 km/h and degree of wetness NG “light”: “medium spray”;
driving speed v=20 km/h and degree of wetness NG “medium”: “light spray”:
driving speed v=60 km/h and degree of wetness NG “medium”: “medium spray”:
driving speed v=100 km/h and degree of wetness NG “medium”: “high spray”
driving speed v=20 km/h and degree of wetness NG “high”: “medium spray”;
driving speed v=60 km/h and degree of wetness NG “high”: “high spray”
driving speed v=100 km/h and degree of wetness NG “medium”: “high spray”

As can be seen in the described example, different quantities of spray can be assigned different degrees of wetness NG with a respective equal driving speed v. In this case, it is provided in a possible exemplary embodiment that, during the automated driving operation, the respective higher degree of wetness NG is assumed and the automated driving operation is carried out depending on the higher degree of wetness NG. If in such a case, the driving speed v is reduced, it can be seen that the degree of wetness NG is “high” with a reduction of the driving speed v from 100 km/h to 60 km/h with “high spray”, for example.

In a further possible embodiment, it is provided that the analysis unit 4 is coupled to a visual rain sensor 7, wherein the degree of wetness NG determined from the noise level difference using the above description is checked for plausibility with data D determined by means of the visual rain sensor 7. Such a rain sensor 7 is, for example, already used in the vehicle 1 for a rain sensor-controlled control system of a windscreen wiper and, for example, is arranged in the region behind a windscreen of the vehicle 1. The reliability of the determination of the degree of wetness NG is further increased by means of such plausibility checking.

In a possible embodiment of the apparatus 2, acoustic signals S1, S2 detected by means of the external microphone 3.1, 3.2 are used independent of the number of the external microphones 3.1, 3.2, for example, in addition to detecting acoustic probe signals of emergency vehicles, present in the surroundings of the vehicle 1.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method comprising:
detecting, during a journey of a vehicle on a road, front acoustic signals using at least one front external microphone arranged in a region of a front end of the vehicle;
detecting, during the journey of the vehicle, rear acoustic signals using at least one rear external microphone arranged in a region of a rear end of the vehicle;
determining, by the vehicle, a noise level difference between the front acoustic signals and the rear acoustic signals; and
determining, by the vehicle, a degree of wetness of the road using the determined noise level difference and a current driving speed of the vehicle with a value matrix.

8. The method of claim 7, wherein the value matrix is determined vehicle-specifically for different degrees of wetness and different vehicle speeds in road tests, wherein, for each of the different degrees of wetness and for each of the different vehicle speeds, noise level differences between the acoustic signals detected by the at least one front external microphone and the at least one rear external microphone are removed in the value matrix.

9. The method of claim 7, wherein an amount of spray is initially determined using the noise level difference and the degree of wetness of the road is derived from the amount of spray, wherein an increasing degree of wetness is determined when there is an increasing amount of spray.

10. The method of claim 9, wherein dependent noise level differences between the acoustic signals detected by the at least one front and at least one rear external microphones are determined in the value matrix for different degrees of wetness and different driving speeds of the vehicle, depending on an amount of spray that is dependent on the degree of wetness, and are removed in the value matrix.

11. The method of claim 7, wherein the degree of wetness determined using the noise level difference is checked for plausibility with data determined by a visual rain sensor.

12. An apparatus comprising:
at least one front external microphone arranged in a region of a front end of a vehicle and configured to detect, during a journey of a vehicle on a road, front acoustic signals;
at least one rear external microphone arranged in a region of a rear end of the vehicle and configured to detect, during the journey of the vehicle, rear acoustic signals; and
an analysis unit configured to determine a noise level difference between the front acoustic signals and the rear acoustic signals and to determine a degree of wetness of the road using the determined noise level difference and a current driving speed of the vehicle with a value matrix.
